(19) United States
(12) Patent Application Publication
(10) Pub. No.: US 2012/0329013 A1
(43) Pub. Date: Dec. 27, 2012

(54) Computer Language Translation and Learning Software

(76) Inventor: Brad Chibos, San Jose, CA (US)

(21) Appl. No.: 13/166,495

(22) Filed: Jun. 22, 2011

(51) Int. Cl. G09B 19/06

(52) U.S. Cl. 434/157

(57) ABSTRACT

A software program is used to translate, define, phonetically pronounce and teach contextual use of select document text to a user. A broad range of computer documents may be manipulated, highlighted, or flagged for immediate use in the program. Tools within the program are used to save selected words, phrases, and passages into user-defined lists. The lists may be further manipulated by adding, deleting, or flagging select list members to enhance user memorization and learning. Multiple languages and dialects may be selected within the program translation tools. The program is especially effective in assisting foreign employees in perfecting language skills and enhancing productivity.

### BACKGROUND OF THE INVENTION

1. Technical Field

The present invention pertains to software translation systems between multiple human languages.

In particular, the present invention pertains to the use of translation, pronunciation, contextual guidance, and user-built learning tools and lists for attaining and perfecting language skills based on text document analysis.

2. Discussion of Related Art

One of the greatest challenges facing foreign employees is the language barrier. Foreign employees are expected to bring immediate technical expertise to their employers, but language proficiency in the employer's domestic language often prevents full and efficient application of the employees' relevant skills to mandated tasks in the new work environment. Language courses, books, and other media often fail to quickly and efficiently teach critical language skills in the short time frame required for foreign employees to adapt to their new work environment.

The problems associated with these traditional methods and media for learning language include: slow speed of processing and assimilation of the materials, deficiency in quality and speed of learning exercises, non-customizable learning options, unsuitable methods of learning for the particular individual's strongest learning style, lack of interactive guides and tools for novel language problems, nonexistent or untimely updates to language guides and databases, lack of multi-language and multi-dialect support, deficient and poorly targeted tutorials for language pronunciation and contextual usage, and lack of support for multiple levels of learning ability.

Generally, the problems described above may be remedied by private personal tutelage from a certified language arts teacher. However, a foreign employee often is unable to make a substantial time and financial investment in order to gain crucial language skills. Such an investment might even deprive the foreign employee of work during normal working hours.

The current state of the art in language software development relies on the separate and exclusive methods of either language translation, mnemonic schemes, tools utilizing visual and text-based information for repetitive learning strategies.

A current variant of the present invention (US20060084041A1) utilizes an internet connection and diary-type language teaching program to connect the document reader and the author of the document for purposes of textual clarification and explanation. Although this method may be useful for native speakers with advanced literary understanding in order to gain deeper insights into the meaning of the text, this method has little use for foreign and less proficient speakers who merely seek an understanding of the plain meaning of the text and to enhance their language skills in the process. The purpose of this method is not to provide definitional, contextual, and phonetic clarification of the text and does not provide customizable tools for individual learning. Furthermore, it is unreasonable for one of multitudes of users to expect instant access to a single author.

Another variant of the present invention (US20090317776A1) utilizes a computer system for assisting a user in practicing the target language. The system stores user records, native languages, target languages, and other values pertaining to the users. However, there is no direct pairing of the computer system with multiple document sources for instant application of software tools. The system is to be used independently and separately from document sources; not as an paired interactive tool.

The related art has provided independent tools for specifically-targeted language skill enhancement. However, not only do many of these tools lack interactivity and the ability to pair with and instantly apply to multiple text documents, these tools do not provide efficient customizable learning strategies for foreign employees to quickly acclimate to and gain rapid proficiency in a non-native work environment.

Accordingly, a need in the art exists to improve the interactivity, efficiency, customizability, language variety, and reasonableness of time and money investment in language learning software tailored to the needs of foreign employees. No current conventional software tool exists that provides customized translation, phonetic pronunciation, context-based explanation, and customizable learning strategies for instant paired application with text documents.

### OBJECTS OF THE INVENTION

Accordingly, it is the object of the invention to provide full text document and user selection-based translation between several human languages.

It is another object of the invention to provide phonetic pronunciation of full text document and user-selected words or passages in several human languages.

Yet another object of the invention is to provide instant explanation and definition of user-selected words or passages of the document in several human languages, dialects, and colloquial language uses.

Another object of the invention is to allow the user to select, highlight, and flag selected words, phrases, and passages from a document and save them in user-built lists for review, study, and memorization.

Another object of the invention is to allow the user to learn saved lists of words, phrases, and passages by selecting effective learning styles, including visual, auditory, and kinesthetic learning styles. The software tools will lead the user through language review via the selected learning method.

It is another object of the invention to test user knowledge and mastery by creating graded tests for the user based on user-selected words, phrases, or passages and on software-identified problematic areas of user knowledge. The software may lead the user through linear progressions of exercises or randomize exercises. Tests may be discrete or mixed sets of reading comprehension, phonetic pronunciation, application of concepts, and drawing and matching exercises for key definitions and phrases, all graded for time and accuracy.

The present invention allows uploading of user progress to a database, which may be monitored by employers or managers. Also, a managing third party may remotely view, access, and manipulate of a user's document via software and internet connection in order to assist the user in problematic areas of knowledge and lead the user through exercises.

The present invention may be paired with text documents, internet webpages, scanned text documents and text-based media, and user inputs of text.

The present invention may utilize text character recognition in order to convert scanned images of text-based media into interactive text documents. The user may then utilize the software to improve the user's language skills by studying the converted image-to-text document.

Furthermore, the present invention may utilize auditory speech recognition in order to convert spoken words and phrases into speech. The software may then save the recorded speech, converted text, and contextual data in order to assist the user in learning the material via the aforementioned learning strategies. The user may also highlight words, phrases, or passages in the text document, select a record and save option in the software, and speak the selected words for recordation, future reference, and comparison with software-generated phonetic pronunciation of the text selection.

The above and still further features, objects, and advantages of the present invention will become apparent upon consideration of the following detailed description of specific embodiments thereof, especially when considered in conjunction with accompanying drawings wherein in like reference numerals in the various figures designate like components.

### SUMMARY OF THE INVENTION

The present invention discloses a computer system of facilitating language learning and enhancing user understanding of computer text comprising a computer system, a module for an on-screen user menu for instantaneous translation of vocabularies between human languages, a module for presentation of definitions for said vocabularies in multiple languages, a module for saving said vocabularies to a list for review by a user, a module for presenting said vocabularies in contextual definition, a module for testing said user's proficiency in using said vocabularies in said list, a module for tracking a user's progress in understanding the selected language and a module for a third party to monitor said user's progress.

In one embodiment of the invention the module for an on-screen user menu for instantaneous translation of vocabularies between human languages further includes a module to hear spoken sample of said vocabularies. In another embodiment of the invention, the module for presentation of definitions for said vocabularies in multiple languages further includes a module to select a dialect of a language for translation purposes. In another embodiment of the invention, the module for presentation of definitions for said vocabularies in multiple languages further includes a module to select a regional colloquial use of a language for translation purposes.

In another embodiment of the invention, the module for presentation of definitions for said vocabularies in multiple languages further includes a module to input text data for software processing via photograph, speech recording, or direct text input to a computer. In another embodiment of the invention, the module for presenting said vocabularies in contextual definition further includes a module to select the greater text passage encompassing the target text selection in order to provide contextual understanding through software processing.

In yet another embodiment of the invention, the module for presenting said vocabularies in contextual definition further includes a module to input keywords in order to assist the software in providing accurate contextual explanation of the selected text. In another embodiment of the invention, the module for testing said user's proficiency in using said vocabularies in said list further includes a module to take a learning style test in order to identify the most effective learning style of the user and present the material in a targeted manner.

In one other embodiment of the invention, the module for testing said user's proficiency in using said vocabularies in said list further includes a module to learn the material visually, through visual pictographic associations with words, word definitions, and word usage in context. In another embodiment of the invention, module for testing said user's proficiency in using said vocabularies in said list further includes a module to learn the material aurally, through listening to software-generated sound samples of the spoken word selection, recording the user's speech of the selected words, and comparing the user's speech with the software speech sample

In another embodiment of the invention, the module for testing said user's proficiency in using said vocabularies in said list further includes a module for the software to generate mixed or random learning styles in testing the user's knowledge of the selected language. In another embodiment of the invention, the module for tracking a user's progress in understanding the selected language further includes a module for visual chart representations of a user's testing scores over time. In another embodiment of the invention, the module for a third party to monitor said user's progress further includes a module to upload user scores to an internet database. In another embodiment of the invention, the module for a third party to monitor said user's progress further includes a module to send scores to a third party. In another embodiment of the invention, the module for allowing a third party to actively monitor a user's reading comprehension, testing, and scoring while the user utilizes the software.

In another aspect of the invention, a computer system of facilitating language learning comprising a computer system, a module that identifies and targets an user's problematic areas of said user's knowledge in a selected language, a module that determines and implements the most effective method of testing said user's knowledge in a selected language based on said user's unique learning style and a module that determines and implement the most effective method of testing said suer's knowledge in a selected language based on said user's language proficiency in said selected language is disclosed.

In one embodiment of the invention, a module that identifies and targets an user's problematic areas of said user's knowledge in a selected language is further comprised of a module that scores assessment and analyzes weaknesses in said user's understanding of context of a selected vocabulary in said selected language; a module that scores assessment and analyzes weaknesses in said suer's understanding of definition of a selected vocabulary in said selected language; and a module that scores assessment and analyzes means to identify weaknesses in the user's understanding of pronunciation of a selected vocabulary in said selected language. In another embodiment of the invention, effective method is comprised of flashcards, visual identification, spoken word identification, crossover of visual and auditory identification, creative writing incorporating selected language, fill-in-the-blank exercises and words games.

### BRIEF DESCRIPTION OF THE DRAWINGS

FIG. 1 is a visual flow diagram of possible uses for the language learner software. Input sources to the software program include text and speech through the internet and text, text images, and user input text directly to the computer. There is a possibility of third party monitoring during software use by managers or other persons.

FIG. 2 is a visual flow diagram sequentially tracing the process of user selection of computer text through processing of text information, display of definition and auditory speech of selected word or phrase, and available options to save the words to a list and options to learn the words.

FIG. 3 is a visual flow diagram of progressions through available user-selectable learning styles. Such options include visual learning, auditory learning, and customizable or mixed and random learning methods. Score tracking is available for a user to track his or her progress through repeated learning exercises. Also, a third party may access the user's progress via internet connection.

FIG. 4 is a visual progression of a user photographically capturing text from any source and transferring the image data to a computer. The language learner software then processes the image information, transcribes it to a text document format for display on the computer, and allows the user to analyze and learn the words and context of the document utilizing software tools.

FIG. 5 is a flow chart progression through user options in the software for context-based analysis and learning of words in the document and methods of learning, testing, and record-keeping of the user-selected words.

FIG. 6 is a visual flow example of a use of the software for preparing a technical presentation. The user selects words or passages for learning through several available methods. The user completes tests and reviews of the selected text until achieving mastery. Finally, the user is prepared to make a successful presentation after mastering the communication of the text.

FIG. 7 is a visual flow example of a use of the software in reading an online news article. The user selects text from the article, inputs a subject keyword into the program in order to facilitate accurate contextual analysis of the document, and proceeds through the learning and mastery phases of understanding the article words and context.

FIG. 8 is a visual progression of a user attaining quick comprehension of a selected text document by first translating the text and then hearing the spoken original text.

FIG. 9 is a visual progression of a user learning the contextual definition of a selected text by navigating available software tools and options.

### DETAILED DESCRIPTION OF THE PREFERRED EMBODIMENTS

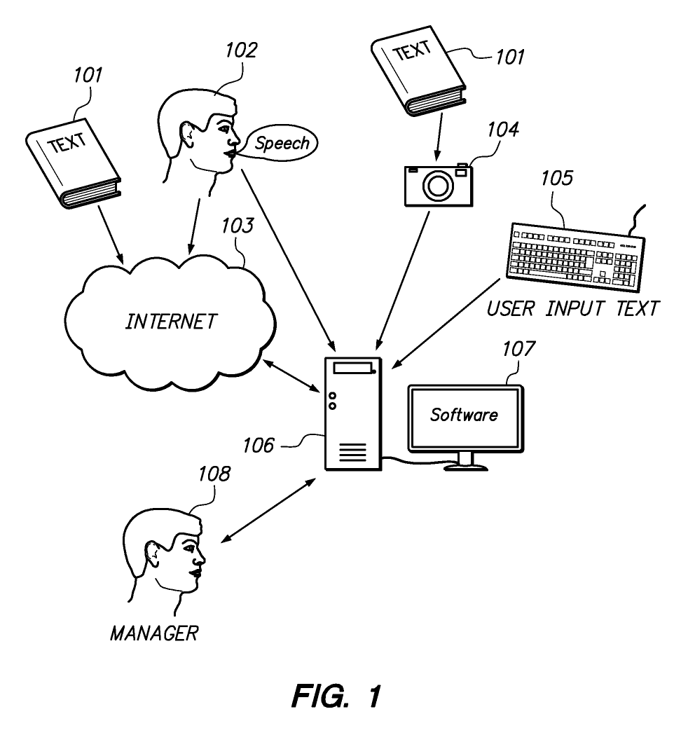

Referring to FIG. 1, which is a visual flow progression of possible inputs to a computer running the language learner software, a textbook or other hard copy text source 101, including magazines, novels, pamphlets and leaflets, and recorded speech 102, including but not limited to spoken and sung words of multiple languages, may be sent through the internet 103 or directly to the computer 106. Text 101 may also be captured with a camera 104 and input directly to the computer or through the internet 103. Furthermore, a user may directly input text into the software program via keyboard 105 or other text input device. The software 107 then processes the user inputs and assembles the data into a legible visual form upon the monitor screen. Also, a third party manager 108 may access the user's progress within the software program live or retrospectively via internet 103 or other computer output connection.

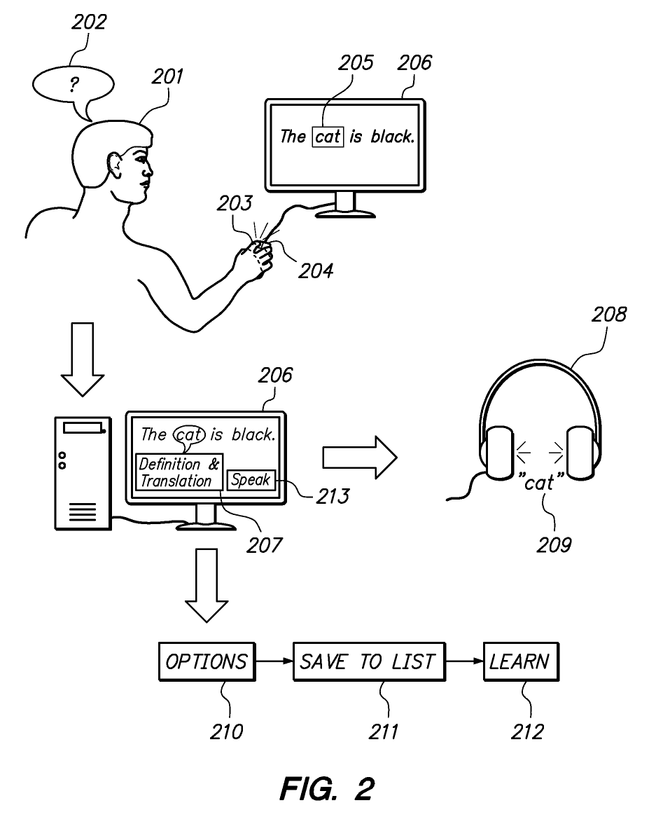

Now referring to FIG. 2, which is a visualization of a user's learning progression of select text using the software program, the user 201 encounters a problem in understanding certain text 202 and clicks 203 and highlights the word in question 205 displayed on the monitor screen 206 with a computer pointing device 204. The software will display an option drop-down menu 207 with the option of defining and translating the highlighted word 205. A further option to hear the spoken word 213 is available in a sub-menu. Upon clicking the spoken word option 213, the user may hear the phonetically-pronounced word 209 through headphones 208 or other sound devices. The user has further options beyond the definition, translation, and pronunciation of the word in question. The user may view more options via an options menu 210, save the word in question to a customizable list of words 211 for future review, and also select various learning methods to learn the word lists from the learn menu 212.

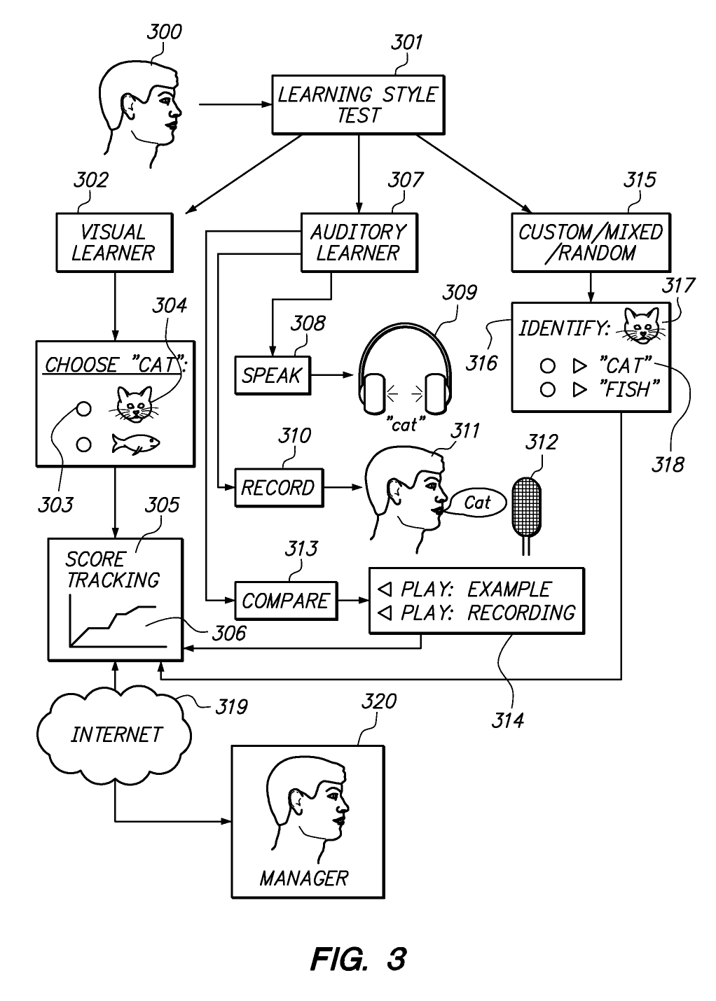

Referring to FIG. 3, which is a visual flow progression of various learning style options available to a user 300, the user may select from several learning styles within a menu depending on which is most effective for the particular user or may elect to take a brief learning style test 301 to determine the most suitable learning style for the user. Such learning style options include but are not limited to visual learner 302, auditory learner 307, and custom, mixed, or random styles 315.

If the user selects the visual learner menu 302, the user may encounter identification exercises wherein the user must match the word in question with one of several pictorial options. The user must click on a checkmark box 303 corresponding to the answer choice represented by a pictorial FIG. 304. Upon completion of one or several tests of vocabulary, a software score tracking system 305 displays a user's progress over time in several display formats 306. A third party manager 320 may access and view the user's progress via internet connection 319.

If the user selects the auditory learner menu 307, the user may select the speak option 308 and hear the spoken pronunciation of the selected word via headphone 309 or other listening device. The user also has the option of recording his or her own voice by selecting the record option 310. Here, the user 311 verbally speaks the selected word into a microphone 312 or other audio recording device that is connected to the computer. The recording sample is saved by the software and the user may then select the compare option 313 in order to play each sample 314 for comparison purposes. Upon completion of one or several sound recording comparison tests, a software score tracking system 305 displays a user's progress over time in several display formats 306. A third party manager 320 may access and view the user's progress via internet connection 319.

If the user selects the custom, mixed, or random menu 315, the user may customize a mix of learning styles to better integrate the vocabulary skills or the software may randomly generate a mix of learning style tests for the user. Upon completion of one or several tests of vocabulary, a software score tracking system 305 displays a user's progress over time in several display formats 306. A third party manager 320 may access and view the user's progress via internet connection 319.

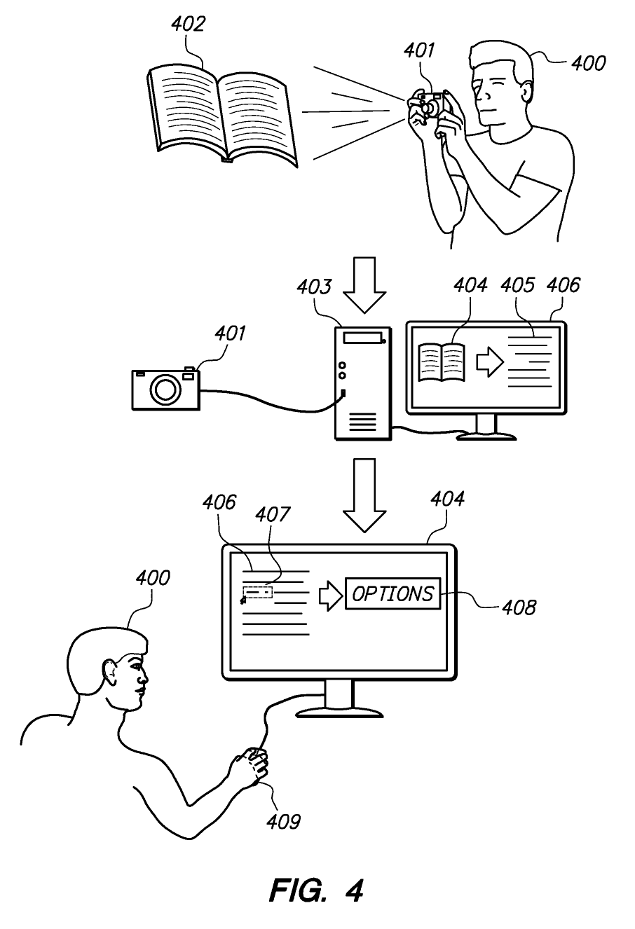

Now, referring to FIG. 4, which is a visual flow representation of the method of capturing text by camera and inputting the data into a computer for text analysis, the user 400 uses a digital camera or other photographic device 401 to capture a selection of text from any source 402. The user then transfers the photographic data into the computer 403. The software displays the photographic image 405 upon the monitor display 404 and processes and transcribes the data into a live text document 406. The user 400 is then able to read the text 406 as if it were any normal computer text document. Upon encountering a question or problem with a word in the document, the user 400 may highlight the text selection 407 using a computer mouse 409 or other computer screen navigation device. The software will then present an options menu 408, from which the user may proceed to further options for learning the selected text in question.

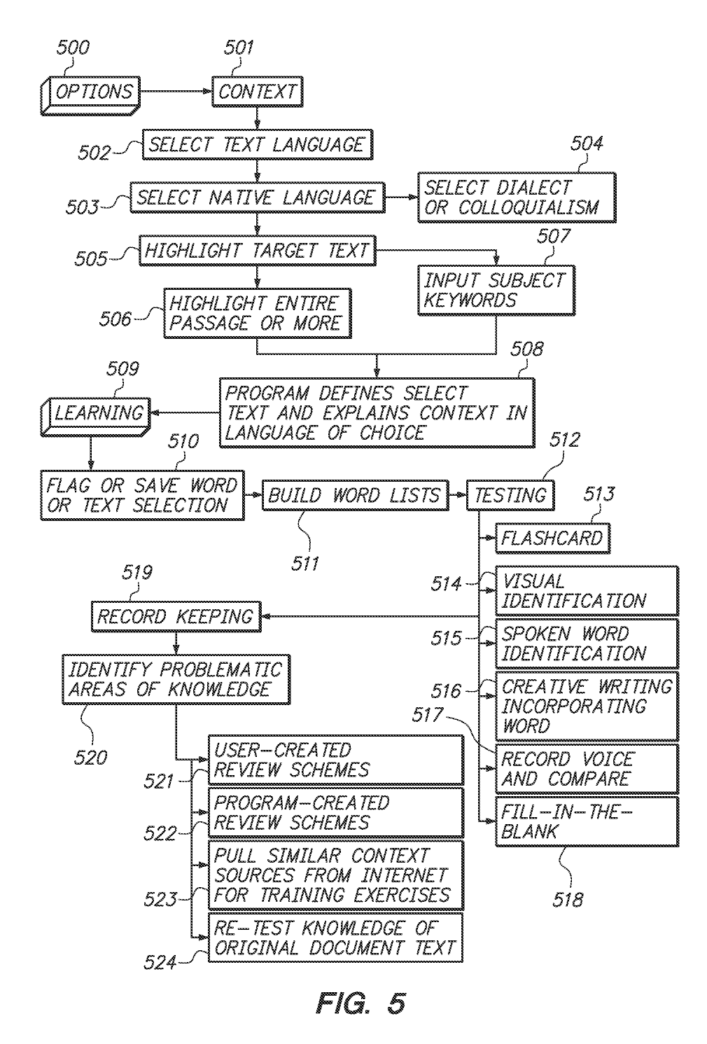

Referring to FIG. 5, which is a flow diagram of the options menu and learning menu and various sub-menus, the user, upon selecting the options menu 500, may select the context option 501, which will teach the user the meaning of the selected text within the context of the greater inclusive text. The user first selects the text language 502, which confirms the actual language of the text at hand. Then, the user selects the user's native language 503, or preferred language in which the user wishes to understand the text selection. The user has a further option of selecting a particular dialect or regional colloquial usage in menu 504, where it is available. Next, the user highlights the target text 505 in the document, and may further input subject keywords 507 in order to help the software determine the particular context of the document or passage, and then highlights the entire passage that includes the target text 506. Then, the program defines the select text and explains the context within meaning of the entire highlighted passage which includes the target text 508.

From this point, the user may proceed to the learning phase 509. The user may flag or save words or text selections 510 into the program memory and also build word lists 511 for review and testing.

The testing options 512 include but are not limited to several effective learning methods, such as flashcards 513, visual identification of words or word definitions or usages with pictures 514, matching written words, definitions or usages with spoken word samples 515, creative writing tests requiring a user to incorporate the word, definition, or usage in question 516, comparison of user voice recording and software sample recording of words, phrases, or usages 516, and fill-in-the-blank exercises incorporating words, definitions, and usages 518. User test results and progress will be tracked in the software record keeping files 519. The user may then review his or her progress and results and identify problematic areas of knowledge 520 for further review and testing. Then, the user may make user-created review schemes using software tools 521, allow the program to create review schemes for the user 522, opt for the program to pull similar context sources from the internet for training exercises 523, and re-test knowledge of the document text and context 524.

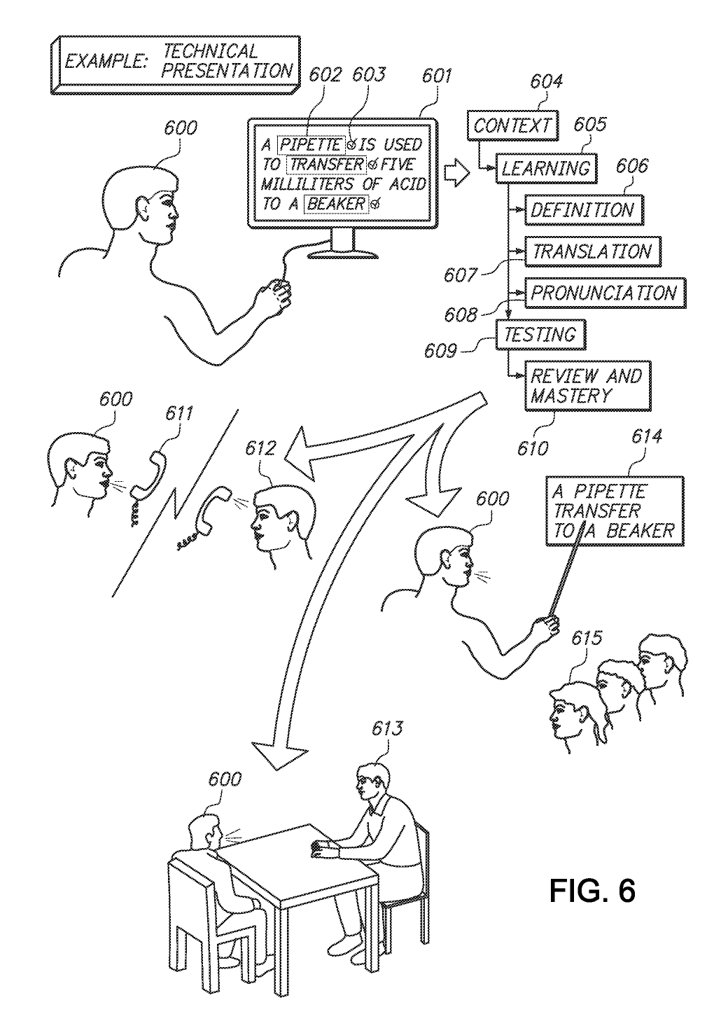

FIG. 6 is a flow diagram exemplifying the steps a foreign employee may take by enlisting the assistance of the language learner software when he or she is unfamiliar with the language of the presentation and needs to prepare a technical presentation. The user 600 encounters several words which are unfamiliar 602 to him or her upon the monitor display 601 and highlights the words in question 603. The software presents a context menu 604, from which the user may select several options, including learning 606, testing 609, and review and mastery 610. The learning menu includes options for clarification of the highlighted words, including definition 606, translation 607, and pronunciation 608. Upon review of these options, the user may progress to the testing phase by selecting the testing option 609, whereby the user may choose several effective testing and review methods including but not limited to flashcards, visual identification, spoken word identification, creative writing incorporating vocabulary, comparison of recorded voice and sample recording, and fill-in-the-blank exercises. The user may review several exercises until mastery is achieved 610, according to the user progress tracking system. Upon achieving mastery of the language material, the user is ready to make a presentation of the text in question. The user 600 may present the material by phone or other teleconference method 611 to a recipient 612. The user 600 may personally present the information to a manager, employer, or other recipient contact 613. The user 600 may also make a lecture-style presentation of the material 614 to an assembled audience 615.

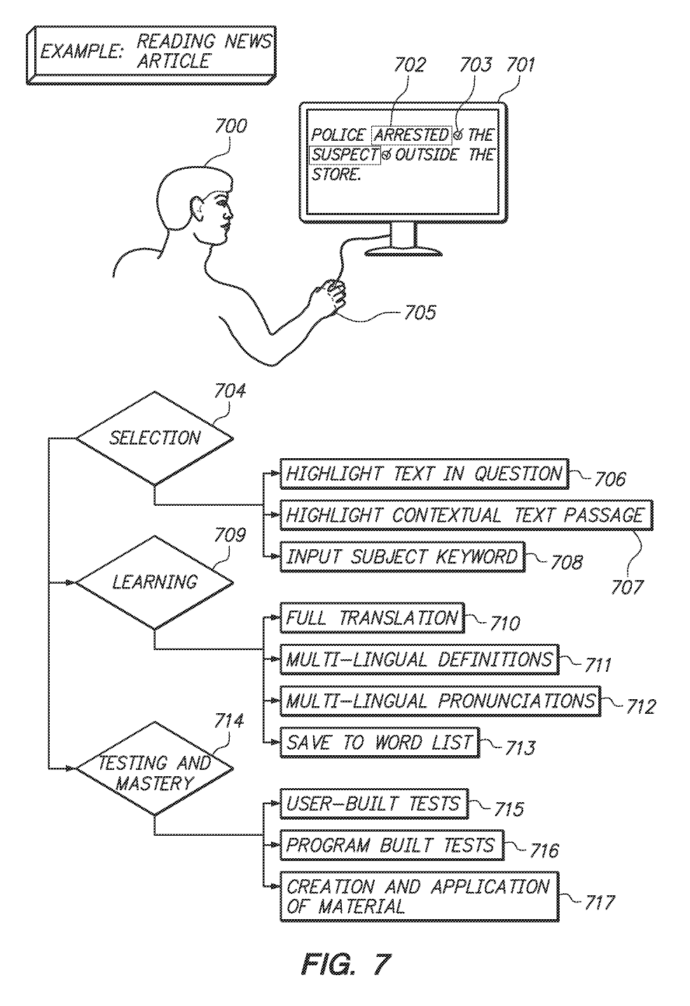

Now referring to FIG. 7, which is a visual flow chart of an application of the software to reading a news article on the computer, the user 700 reads the news article on a monitor display 701 and highlights questionable words or phrases of interest 702 with a mouse or other navigation device 705. Upon highlighting the text in the document, the software presents options menus 703 to the user. In the initial text selection process 704, the user highlights the text in question 706, and may further highlight the overarching text passage in order to clarify the context of the passage 707. Moreover, the user may input subject keywords 708 to assist the software in identifying the proper context of the passage.

Next, in the learning options process 709, the user encounters several options, including full text translation 710, which translates the selected text to a language of the user's choice, multilingual definitions 711, which provides the user with definitions of selected words in several selectable languages, multilingual pronunciations 712, which provides sound samples of phonetic pronunciation of the words in question, and the option to save the words to a list in the program 713.

Upon selecting the testing and mastery option 714, the use may custom-build tests 715 for review of the selected material, opt for the program to build tests for the user 716 either in randomized fashion or in consideration of the user's recorded strengths and weaknesses, and the user may opt to create and apply the selected material 717 in further exercises.

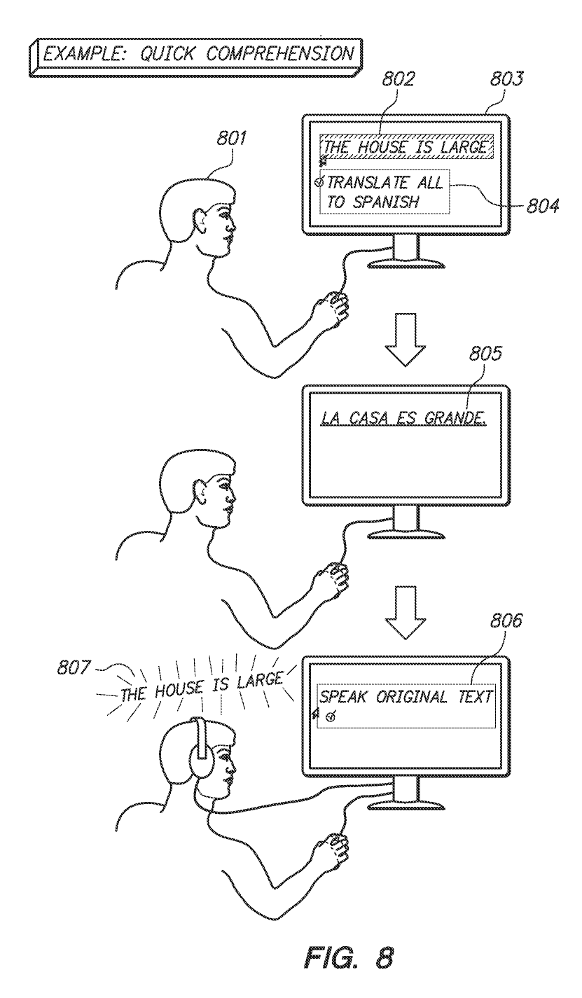

Referring to FIG. 8, which is an example of a quick comprehension strategy for a foreign employee to gain rapid understanding of a text in question, the user 801 views the text on a display monitor 803 and selects text which he or she does not understand. A drop-down menu 804 gives the user the option to translate the entire text selection into a language of choice (in this example: Spanish). Upon selecting the translation option, the text is displayed in the language of choice 805. The user may then select a further option to listen to a spoken sample of the original text in the user's language of choice 806. The user listens to the sound sample 807 via headphones or other listening device. Thus, the user attains a rapid understanding of the word definition, sees the translated text for referential understanding, and hears the word in both the native displayed language and a selected language of choice for full understanding of the text.

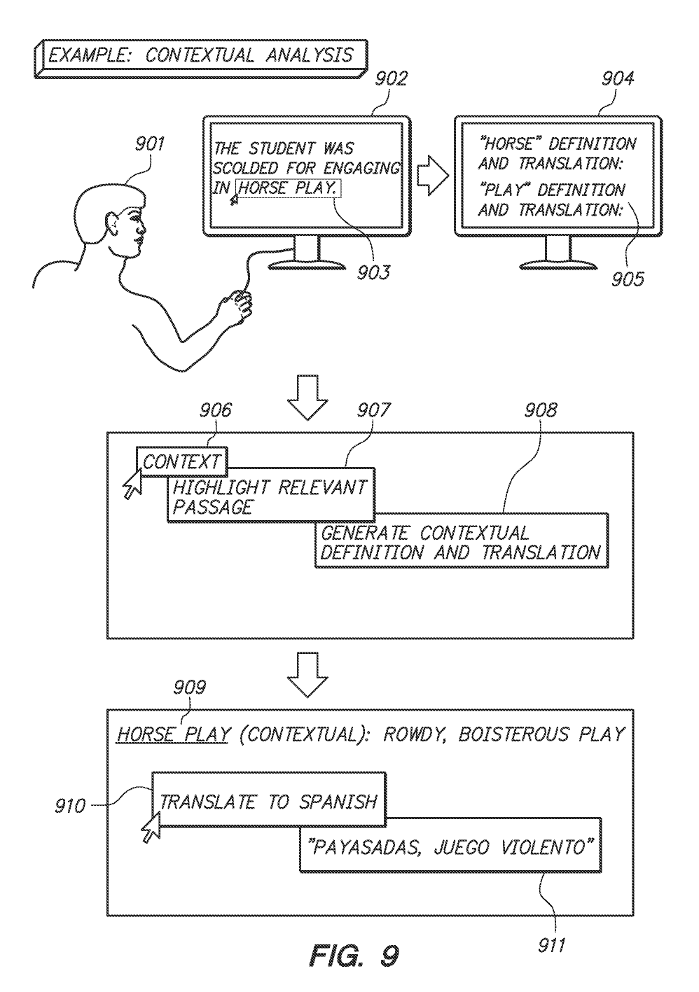

Referring to FIG. 9, which is an example of a user gaining contextual understanding of a text in question, the user 901 views a text on a display monitor 902 and selects a portion of text that he or she does not understand 903. In this example, the words “horse” and “play” are displayed, and normally, a program would present the definitions and translation for each word separately. Here, the user has the enhanced option of selecting a context menu 906, which asks the user to highlight the relevant over-encompassing text passage 907 and allows the user to select the option to generate a contextual definition and translation 908 of the target word or words. In this case, the program displays the contextual definition of the combined words “horse” and “play,” which is different from the definition of either word, alone. Furthermore, the user has the option of translating the paired words in context to another language of choice 910. The translated result is then displayed 911.

### REFERENCES CITED

U.S. PATENT DOCUMENTS
US20060084041A1
US20090317776A1

What is claimed is:

1. A computer system of facilitating language learning and enhancing user understanding of computer text comprising:
(a) computer system;
(a) a module for an on-screen user menu for instantaneous translation of vocabularies between human languages;
(b) a module for presentation of definitions for said vocabularies in multiple languages;
(c) a module for saving said vocabularies to a list for review by a user;
(d) a module for presenting said vocabularies in contextual definition;
(e) a module for testing said user's proficiency in using said vocabularies in said list;
(f) a module for tracking a user's progress in understanding the selected language;
(g) a module for a third party to monitor said user's progress.

2. The system of claim 1, wherein said module for an on-screen user menu for instantaneous translation of vocabularies between human languages further includes a module to hear spoken sample of said vocabularies.

3. The system of claim 1, wherein said module for presentation of definitions for said vocabularies in multiple languages further includes a module to select a dialect of a language for translation purposes.

4. The system of claim 1, wherein said module for presentation of definitions for said vocabularies in multiple languages further includes a module to select a regional colloquial use of a language for translation purposes.

5. The system of claim 1, wherein said module for presentation of definitions for said vocabularies in multiple languages further includes a module to input text data for software processing via photograph, speech recording, or direct text input to a computer.

6. The system of claim 1, wherein said module for presenting said vocabularies in contextual definition further includes a module to select the greater text passage encompassing the target text selection in order to provide contextual understanding through software processing.

7. The system of claim 1, wherein said module for presenting said vocabularies in contextual definition further includes a module to input keywords in order to assist the software in providing accurate contextual explanation of the selected text.

8. The system of claim 1, wherein said module for testing said user's proficiency in using said vocabularies in said list further includes a module to take a learning style test in order to identify the most effective learning style of the user and present the material in a targeted manner.

9. The system of claim 1, wherein said module for testing said user's proficiency in using said vocabularies in said list further includes a module to learn the material visually, through visual pictographic associations with words, word definitions, and word usage in context.

10. The system of claim 1, wherein said module for testing said user's proficiency in using said vocabularies in said list further includes a module to learn the material aurally, through listening to software-generated sound samples of the spoken word selection, recording the user's speech of the selected words, and comparing the user's speech with the software speech sample

11. The system of claim 1, wherein said module for testing said user's proficiency in using said vocabularies in said list further includes a module for the software to generate mixed or random learning styles in testing the user's knowledge of the selected language.

12. The system of claim 1, wherein said module for tracking a user's progress in understanding the selected language further includes a module for visual chart representations of a user's testing scores over time.

13. The system of claim 1, wherein said module for a third party to monitor said user's progress further includes a module to upload user scores to an internet database.

14. The system of claim 1, wherein said module for a third party to monitor said user's progress further includes a module to send scores to a third party.

15. The system of claim 1, wherein said module for allowing a third party to actively monitor a user's reading comprehension, testing, and scoring while the user utilizes the software.

16. A computer system of facilitating language learning comprising:
(a) a computer system:
(b) a module that identifies and targets an user's problematic areas of said user's knowledge in a selected language;
(c) a module that determines and implements the most effective method of testing said user's knowledge in a selected language based on said user's unique learning style;
(d) a module that determines and implement the most effective method of testing said suer's knowledge in a selected language based on said user's language proficiency in said selected language.

17. The system of claim 16 wherein said module that identifies and targets an user's problematic areas of said user's knowledge in a selected language is further comprised of:
i. a module that scores assessment and analyzes weaknesses in said user's understanding of context of a selected vocabulary in said selected language;
ii. a module that scores assessment and analyzes weaknesses in said suer's understanding of definition of a selected vocabulary in said selected language; and
iii. a module that scores assessment and analyzes means to identify weaknesses in the user's understanding of pronunciation of a selected vocabulary in said selected language.

18. The system of claim 16 wherein said effective method is comprised of flashcards, visual identification, spoken word identification, crossover of visual and auditory identification, creative writing incorporating selected language, fill-in-the-blank exercises and words games.
